(19) United States
(12) Patent Application Publication
(10) Pub. No.: US 2007/0031595 A1
(43) Pub. Date: Feb. 8, 2007

(54) Process for 360 degree soft touch molding on an object core and product made therewith

(76) Inventor: Richard B. Fox, Smithfield, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/294,793

(22) Filed: Dec. 6, 2005

Related U.S. Application Data
(60) Provisional application No. 60/705,279, filed on Aug. 3, 2005.

(51) Int. Cl. B05D 5/00; B05D 1/18; B29C 45/14; B29C 44/12

(52) U.S. Cl. 427/243; 264/328.2; 264/279; 264/279.1; 264/129; 264/334; 264/46.4; 427/430.1

(57) ABSTRACT

A process for making a soft touch outer surface for an object includes the steps of first providing a core to receive a soft touch outer surface thereon and providing a mold member having a mold cavity. The core is then placed inside the mold cavity. A low durometer elastomer, having a Shore 00 hardness of 70 or less, or a low density foamed plastic, having a specific gravity of specific gravity between 0.1 and 0.7 is injected into the mold cavity to surround the core in 360 degrees to provide a predetermined thickness of a cushioning layer. The core, with cushioning layer thereon, is demolded from the mold by which it was formed. The outer surface of the cushioning layer is then covered with a finish layer.

### CROSS-REFERENCE TO RELATED APPLICATIONS

This application claims priority from prior U.S. Provisional Application Ser. No. 60/705,279 filed on Aug. 3, 2005.

### BACKGROUND OF THE INVENTION

The present invention generally relates to the process of creating an ergonomic handle, grip, or other such small object that is comfortable to the touch. More specifically, the present invention relates to the process of creating a grip or a small object wherein a rigid or semi-rigid interior component, such as a core, is fully encased in a molded superstructure of low durometer elastomer, such as urethane, or a low density foamed plastic and the surface thereof is painted or covered with fabric for aesthetics and durability.

In the prior art, there are various objects, surfaces and substrates that are hard to the touch. There is a desire to make those surfaces more comfortable for human contact. Also, it is desirable to make the surfaces more ergonomic where contact with the human body can be better positioned for optimal use of the underlying article.

In the prior art in general, cushioning material is applied to or secured to an underlying substrate in a number of different ways. Rubber materials or other relatively higher durometer elastomers have been molded around objects in the prior art. These materials differ from the cushioning layer in the present invention in that they are of a higher durometer than shore 00 hardness of 70 and are thus significantly firmer that the elastomers or foams prescribed herein. These higher durometer materials can be molded in traditional injection molding equipment. The lower durometer elastomers utilized in the present invention cannot be molded by traditional injection molding equipment. They have very long cure times and are generally extremely tacky. The present invention describes a process wherein these lower durometer and low density materials can be successfully molded in 360 degrees around a rigid or semi rigid core.

The higher durometer cushioning materials such as rubber provide better friction with fingertips or hands than hard plastic, but have very limited ability to conform to finger shape under pressure when compared to the low durometer elastomers and low density foams described in the present invention.

Low durometer (below shore 00 hardness of 70) have been utilized in a non-molded manner as a cushioning layer for a grip in the prior art. In a first prior art example 10, as seen in FIG. 1, an extruded tube 12 of low durometer elastomer, having unitary thickness is expanded and then slid over an object core 14 to be cushioned and then contracted (by heat shrinking, for example) to provide a layer of cushioning to the core. More specifically, the object core 14 is a flashlight body which communicates with the hands of a user. The tube 12 of cushioning material is slid onto the flashlight body 14 with the assistance of a lubricant material. In this example, while the tube 12 of cushioning material assumes the shape of the rigid core 14 beneath, i.e. cylindrical, where the cushioning layer 12 is of a uniform thickness profile over the core 14. In other prior art attempts, low durometer material is commonly cast as a sheet or web and then applied to the surface of the rigid core as a wrap or patch.

In a second prior art example 20, as seen in FIG. 2, a low durometer liquid gel 22 is contained within flexible bags 24 and is sealed within an outer cylindrical sleeve 26 which could be rubber or plastic. The result is a cylindrical bag or series of bags 24 filled with gel 22 that is then slid over the body of the core 28, such as a tool handle, for cushioning thereof. The bags 24 are sandwiched between the underlying object core 28 and the sleeve layer 26 which is also typically also slid over the liquid-holding bags 24. Thus, to provide the very low durometer liquid cushioning, bags 24 must be used which are extremely limited as to how they can be configured on the object core 28. In other prior art, low durometer materials have been used as a dip or coating to again apply a uniform thickness to an object.

The primary shortcoming of prior art methods, that employ low durometer elastomers as cushioning, is that the low durometer materials are applied in a constant thickness about the substrate. Thus, the substrate itself defines the outer configuration and shape of what the article will look like after the cushioning material has been applied. Essentially, prior art cushioning layers with low durometer elastomers are simply added layers that make the finished article slightly larger where the outer layer of uniform thickness is now a cushioning layer. The low durometer material being of uniform thickness does not allow for the ergonomic designs incorporating more or less cushioning material at various places within the object. It also limits the aesthetic appeal of the finished product, since a uniform outer layer reduces the ability to achieve a highly detailed shape in the finished object.

As noted previously, prior art rubber grips or higher durometer elastomers are molded in shapes that are not uniform but they do not exhibit the highly desirable conforming visco-elastic properties of the low durometer elastomers or low density foamed plastics. Low durometer materials with long cure times and extreme tackiness cannot be molded using prior art methods, particularly, in non-uniform thicknesses.

In view of the foregoing, there is a need for a process which can create a grip or object that has a low durometer or low density material applied as a non-uniform coating or layer of cushioning. There is a need for a cushioning layer on a substrate that can have variable thicknesses at different points over the substrate as well as varying amounts of cushioning. There is a need for a cushioning material that is able to be molded directly to a substrate, surrounding it in 360 degrees and finished, if desired. There is a need for a low durometer cushioning layer around an object that can have a detailed and attractive appearance.

### SUMMARY OF THE INVENTION

The present invention preserves the advantages of prior art processes for 360 soft touch molding on a substrate and products made therefrom. In addition, it provides new advantages not found in currently available processes and products and overcomes many disadvantages of such currently available processes and products.

The invention is generally directed to a novel and unique process for forming a cushioning layer about a core, which could be, for example, a writing instrument, a tool handle, the handle of a razor, an eyeglass frame or beverage container.

The process for making a soft touch outer surface for an object includes the steps of first providing a core to receive a soft touch outer surface thereon and providing a mold member having a mold cavity. The core is then placed inside the mold cavity. A low durometer elastomer, having a Shore 00 hardness of 70 or less, or a low density foamed plastic, having a specific gravity of specific gravity between 0.1 and 0.8 is injected into the mold cavity to surround the core in 360 degrees to provide a predetermined thickness of a cushioning layer. The core, with cushioning layer thereon, is demolded from the mold by which it was formed. The outer surface of the cushioning layer is then covered with a finish layer.

It is therefore an object to provide process for forming an outer cushioning layer for an object core to make interaction with that object more comfortable and ergonomic.

It is an object of the present invention to provide a process for forming a cushioning layer for an object core that is softer and more comfortable than prior art cushioning layers.

It is a further object of the present invention to provide a process for forming a cushioning layer that is more customizable and flexible than prior art processes.

Another object of the present invention is to provide a process that can form a cushioning layer that has a non-uniform profile thickness over the surface of the underlying core object.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of a prior art uniform thickness cushioning layer that has been slid onto an object core;

FIG. 2 is a cross-sectional view of an object core that is cushioned by a number of liquid-containing bags with a outer cylindrical sleeve thereabout;

FIG. 3A is a top view of a first mold half with a object core loaded therein in accordance with the present invention;

FIG. 3B is a top view of a second mold half that is matable with the first mold half of FIG. 3A in accordance with the present invention;

FIG. 4 is an elevational view illustrating a finish layer being sprayed onto the outer surface of the mold part in accordance with the present invention;

FIG. 5 is an elevational view illustrating a finish layer being applied to the molded part by dipping in accordance with the present invention;

FIG. 6 is an elevational view illustrating a tubular finish layer being applied to the molded part in accordance with the present invention;

FIG. 7 is a cross-sectional view through the line 7-7 of FIG. 4 in accordance with the present invention;

FIG. 8 is a cross-sectional view through the line 8-8 of FIG. 5 in accordance with the present invention; and

FIG. 9 is a top view of the in-line process of the present invention.

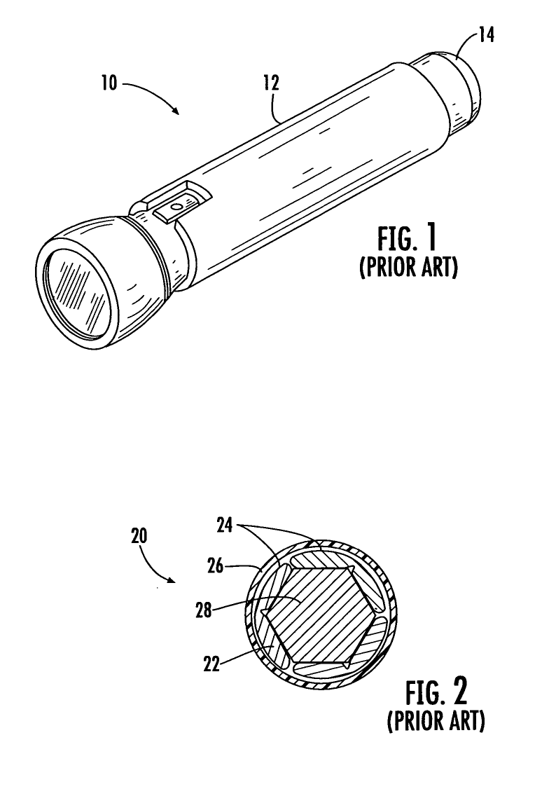

### DETAILED DESCRIPTION OF THE PREFERRED EMBODIMENT

In accordance with the present invention, a new and novel process for 360 degree molding on and/or about a substrate is provided. More specifically, the process of the present invention provides an effective method of creating a grip or small object that has a rigid or semi-rigid core and is covered in 360 degrees with low durometer or low density material which has differing thickness at various points over the core substrate. The process is outlined below can be carried out for providing a finished cushioned layer to any object core, such as a barrel of a writing instrument or tool handle. For ease of discussion, the process of the present invention is described in detail herein in connection with the process of forming a finished cushioned layer on the barrel of a writing instrument, however, this is just one example of how the process of the present invention can be implemented. The formation of finished cushioned layers on any other type of object core is within the scope of the present invention.

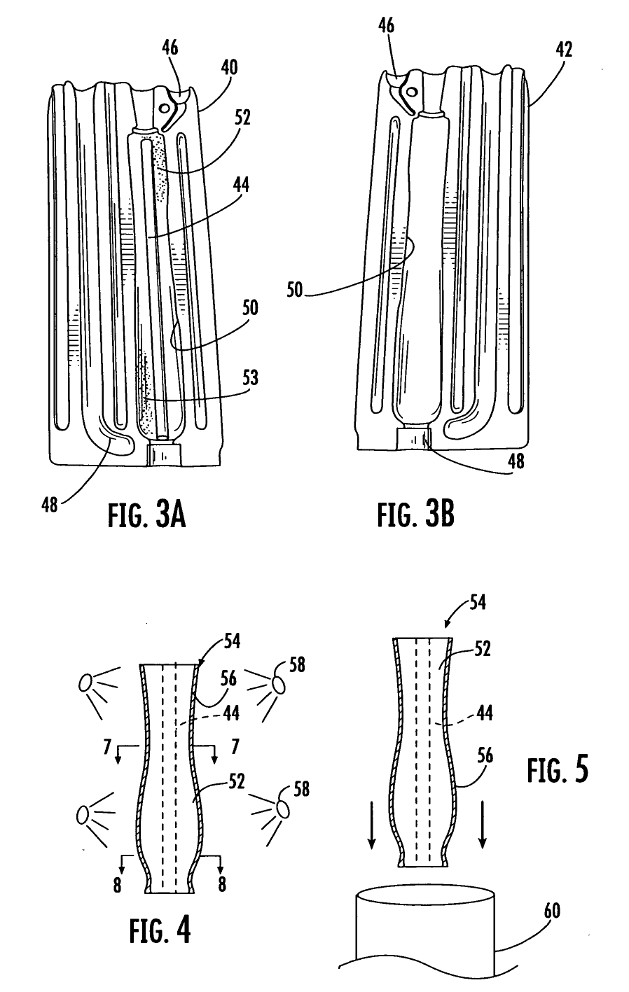

Referring first to FIGS. 3A and 3B, a first mold half 40 and a mating complementary second mold half 42 are prepared with a mold release coating 53 and pre-heated. A mold release 53, such as 19 mdr (axel plastics), is preferably employed but other suitable release materials can be used. Also, known methods for heating molds is used, such as infrared or electric heaters. In FIG. 3A, the pen barrel 44 is loaded and seated in place within cavity 50 on the first mold half 40. The second mold half 42 is mated with the first mold half 40 to thereby close about the barrel 44. Next, the desired cushioning material 52, such as urethane with a Shore 00 hardness in the range of 20-65, is injected therein via input gate 46. Material less than Shore 00 hardness of 55 is preferred. Output gate 48 is also provided to accommodate overflow. The balancing of the materials and curing thereof is then automatically executed. Multiple molds are preferably used to improve production efficiency and increase capacity.

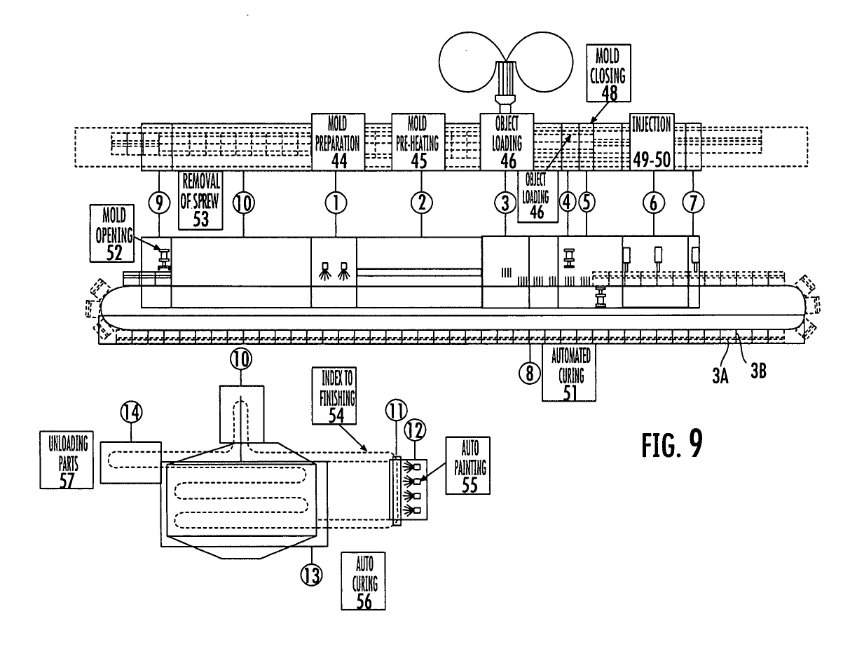

As will be described in connection with FIG. 9 below, the molds 40, 42 proceed through the process by conveyor in series to allow for the long curing time of the low durometer elastomer or low density foam plastic material. The process is timed and contains the appropriate number of mold frames such that the molded part reaches the demolding step in the process at a point where the elastomer or foam has cured. The mold 40, 42 is then opened and the part is unloaded. Sprew materials are removed to clean up the part. The outer surface of the cushioning later is then optionally painted or coated with a fabric layer to provide an outer finish layer. It is also conceived as part of the present invention, that the rigid or semi rigid core can be of sufficient length so that it could be cut into multiple finished parts after the molding process. This can further enhance the efficiency of the process for grips or objects whose shape permits this.

The material used in the present invention is preferably a low durometer elastomer, as mentioned above. However, it is also contemplated that the material could also be a low density foamed plastic with a specific gravity between 0.9 and 1.45. This foamed plastic could be foamed Polyurethane, Polyethelene, EVA or other material.

Unlike the very low durometer and very low density materials employed in the present invention (e.g. shore 70 and below), rubber and higher durometer materials, such as urethanes and high density foams are used in the prior art. These higher durometer materials do not have the tackiness or long cure times and can thus be molded by standard injection molding processes. Because of the tackiness, the low durometer products need to be molded with no flashing since they cannot be trimmed. Also, they require specialized release coatings in the molds to allow them to come out of the mold and still be painted. The long cure times of these materials are accommodated by utilizing numerous molds moving in series through the process.

Once the molding material is formed about the core, they are preferably finished with a finish layer. For example, the parts 54 can be painted or covered with a tubular knit or braided fabric to attain a desirable aesthetic and durable finish. As in FIG. 4, the resultant part, generally referred to as 54, includes the desired object core 44, which in this case is a pen barrel, and outer layer of low durometer or low density foamed material 52. In FIG. 4, the finish layer 56 is a layer of paint that has been sprayed onto the outer surface of the cushioning material 52 by spray guns 58. Thus, the tacky cushioning layer 52 is now sealed and finished to provide an attractive and comfortable cushioned pen barrel. Moreover, the paint can be selected to be a certain color to further enhance the aesthetics of the finished part 54.

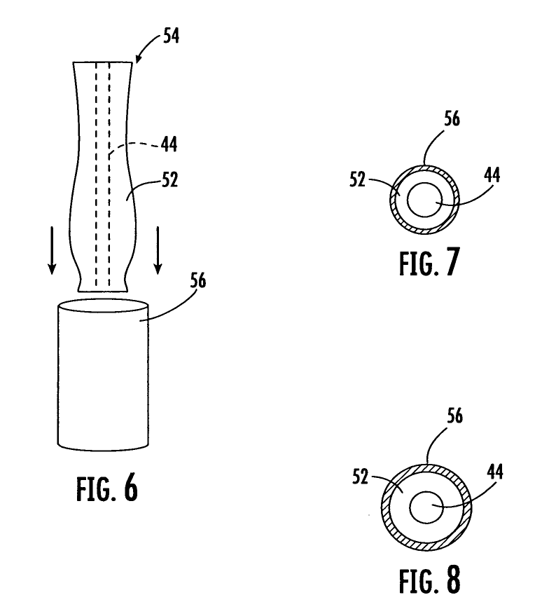

Also, as in FIG. 5, the finish layer 56 can be alternatively formed by dipping the core 44 and cushioning material 52 thereon into paint reservoir 60. Still further, the finish layer 56 can be a tubular fabric, as seen in FIG. 6, where it is slid over the core 44 and cushioning material 52 thereon. The fabric 56 be adhered to the outer surface of the cushioning material 52 by many different ways, such as by heat shrinking or by adhesive.

Where the prior art does use low durometer materials in cushioning of small objects and grips, they are used in sleeves, tubes, sheets or dips which provide only for uniform thickness of cushioning over a substrate. In contrast, the molding technique used in the present is unique and novel over the prior art because it can provide different profiles of low durometer elastomer or low density foam about the surface of the substrate. For example, the region of the cushioning layer of a pen barrel that is positioned underneath the thumb and middle finger may be thicker than the rest of the cushioning layer to provide additional cushioning where the user's fingers contact the pen barrel. For example, FIG. 7 shows a cross-sectional view through the line 7-7 of FIG. 4 and FIG. 8 shows a cross-section view through the line 8-8 of FIG. 4 to illustrate that the process of the present invention is capable of providing different thickness profiles over the surface of the same part 54. In this example, FIG. 7 shows that the cushioning layer 52 in the middle of the pen barrel is less thick than the cushioning layer 52 under the user's fingers which is shown in FIG. 8. This ability is unique to the process of the present invention.

Also, a given area may be injected with higher or lower durometer material than other parts of the layer. In the pen example, the regions under the thumb and middle finger may be lower durometer material or may be of a thicker profile for added comfort and to assist the user in ergonomically orienting the pen body in their fingers.

Thus, in accordance with the present invention, varying profiles of cushioning material with varying thicknesses and hardnesses can be provided over the surface of the substrate and applied to the substrate in a single 360 degree molding operation to form a unique and novel cushioned product. A significant and important advantage of the low durometer materials of the present invention is that they often exhibit visco-elastic properties and thus conform to the shape of the hand or other contact point.

In accordance with the present invention, other finished products of different molding materials can be formed using the 360 molding process of the present invention. These include, pen barrels, shaving razor handles, hand tools, brushes, toothbrushes, eyeglasses, lint brushes, toys and novelties as well as luggage handles and drinking bottles or other liquid containers. In general, any substrate could be molded 360 degrees therearound using the process of the present invention.

An outer finish layer 56, such as paint or fabric, although optional, is preferably provided. This finish layer that covers around the low durometer or low density cushioning layer 52 is often critical since the low durometer elastomers are generally very tacky and/or not durable to the touch. It is critical that the paint or fabric utilized have a significant amount of stretch to be able to conform to the movement of the low durometer cushion layer.

Also, instead of paint or fabric, various films may be applied to the 360 degree molding part to further enhance the article. For example, a soft outer polyurethane film can be applied to the low durometer elastomer on a pen barrel to provide an outer skin. These alternative films can be applied using similar techniques as described in connection with FIGS. 4-6. Other films can be utilized depending on the application or requirements. These films can be polyurethane, Polyester, Polypropylene, Nylon, Polyethelene or other appropriate material. These films can be printed or painted before or after applying them to the object. These films may be applied as tubes or wrapped around the object. In general, depending upon the shape, it may be desirable for the film layer to have heat shrink properties. In this way the film can be shrunk after application to conform directly to the object shape. In general, the outside surface of the 360 degree molded material can be further modified to suit the application at hand.

### EXAMPLE

### Beverage Container

Below is a summary outline of the steps in connection with the process of the present invention in an example, as shown in FIG. 9, where the object core is a rigid barrel insert for a writing instrument. The materials that are used require and extended cure cycle to cure and are very tacky until they are finished with a painted coating or covered with a fabric finish layer tube.

1. Mold preparation—the mold halves 3A, 3B are coated with a release coating, at location #1, to prevent the tacky cushioning material 52 from sticking to the molds 3A, 3B which would damage the parts 54 or the molds 3A, 3B or both.

2. Mold pre-heating—the mold halves 3A, 3B are preheated at location #2 to reduce the gel time so molds are not evacuated as they are turned upside down as the machine indexes.

3. Object Core Loading—object cores 44, namely, an inner barrels of a writing instrument, such as pen, are automatically loaded and positioned with high tolerance, at location #3, to insure precisely matched component during post assembly.

4. Automated inner barrel seating—to insure that the positioned inner barrels 44 are seated against the positive stops prior to indexing to the mold closing station at location #4.

5. Automated closing of the molds—the molds, of the type shown in FIGS. 3A and 3B, are a two piece design and are laying flat and open until the inner barrel is placed and positioned. Then, molds halves 3A, 3B are automatically close and then locked at location #5.

6. Injection of Cushioning Material. The chemical component mix is automatically injected into the closed mold 3A, 3B at location #6. The soft touch grip cushioning material 52, which could be a low durometer elastomeric material or low density foamed plastic, is injected. In this example, a low durometer elastomer is preferred for a pen barrel 44. It is in a liquid state therefore positioning of the injection heads #6 to the molds 3A, 3B is critical, the dose and delivery of the chemicals to the mold is also critical as variations will cause changes in the softness of the finished pen part 56. The system 100 provides for a dual injection system which permits the molding of two different materials which may have different characteristics, such as different durometers or specific gravities.

7. Automated balancing of materials. The materials in the mold are automatically balance in the filled mold at location #6 to reduce spew size and scrap.

8. Automated curing. After the molds are filled with the cushioning material they are indexed at location #7 around an over/under chain conveyor #8, this allows the parts 56 to cure while the system 100 is performing the operations 2-7 above.

9. Automated opening of the closed molds. The molds 3A, 3B are unlocked and opened to allow molded parts to be unloaded or demolded at location #9. The use of a release coating facilitates this process. The design of the opener as well as the mold carriers is critical as we must not bend or break the inner barrel during this process step.

10. Removal of sprew materials. This process is carried out to clean up the molded part prior to application of the finish layer at location #10.

11. Indexing of parts for finish layer application. The molded parts are unloaded and loading onto the automated coating line at location #11. Parts are placed on carriers custom designed to process the soft touch pens. The carriers are attached to a chain conveyor that indexes the uncoated parts to a painting/coating station at location #11.

12. Automated painting of the parts. Preferably, up to (3) paint guns #12 to apply the custom formulated coating of paint 56 at location #12. The guns #12 automatically index up and down as the soft touch pen parts 56 are turning and moving through this station. Automated rotation of the molded parts insure 360 coverage of the finish layer coating.

13. Automated curing of coated parts. The coated parts are conveyed through a series of positions in a heated environment at location #13.

14. Unloading of parts. The parts are unloaded and placed in cartons for post curing at location #14.

In view of the foregoing, a new and improved process for 360 degree molding around a substrate and product made therewith is provided. With the 360 degree molding process of the present invention, materials can be effectively applied 360 degrees on a substrate to provide a superior end product that has comfort and ergonomics that cannot be formed using known prior art techniques for applying these low durometer or low density materials.

It would be appreciated by those skilled in the art that various changes and modifications can be made to the illustrated embodiments without departing from the spirit of the present invention. All such modifications and changes are intended to be covered by the appended claims.

What is claimed is:

1. A process for making a soft touch outer surface for an object, comprising the steps of:
providing a core to receive a soft touch outer surface thereon;
providing a mold member having a mold cavity;
placing the core inside the mold cavity;
injecting a low durometer elastomer, having a Shore 00 hardness of 70 or less, into the mold cavity to surround the core in 360 degrees with a predetermined thickness;
demolding the core with low durometer elastomer thereon having an outer surface; and
covering the outer surface of the low durometer elastomer with a finish layer.

2. The process of claim 1, wherein the finish layer is paint.

3. The process of claim 2, wherein the paint is elastomeric.

4. The process of claim 2, wherein the paint is an elastomeric polyurethane.

5. The process of claim 2, further comprising the step of:
spraying paint onto the outer surface of the low durometer elastomer.

6. The process of claim 5, further comprising the step of:
rotating the core 360 degrees during the step of spraying paint onto the outer surface of the low durometer elastomer.

7. The process of claim 2, further comprising the step of:
covering paint on the outer surface of the low durometer elastomer by dipping.

8. The process of claim 1, wherein the finish layer is fabric.

9. The process of claim 8, wherein the fabric is tubular in configuration.

10. The process of claim 8, wherein the fabric is made of a material selected from the group consisting of braided, circular knit and heat shrinkable.

11. The process of claim 1, wherein the finish layer is film.

12. The process of claim 11, wherein the film is made of a material selected from the group consisting of: polyurethane, EVA, polyethylene, polyester, nylon and polypropylene.

13. The process of claim 1, wherein the core is rigid.

14. The process of claim 1, wherein the core is semi-rigid.

15. The process of claim 1, wherein the core is a writing instrument.

16. The process of claim 1, wherein the core is handle of a razor.

17. The process of claim 1, wherein the core is an eyeglass frame.

18. The process of claim 1, wherein the core is a beverage container.

19. The process of claim 1, wherein the low durometer elastomer has a cure time of greater than 1 minute.

20. The process of claim 1, wherein the low durometer elastomer has a cure time of greater than 3 minutes.

21. The process of claim 1, wherein the mold member is made of plastic.

22. The process of claim 1, further comprising the step of:
covering the mold member with a non-transferring release agent prior to injecting the low durometer elastomer into the mold cavity.

23. The process in of claim 22, wherein the release agent is cross-linked.

24. The process of claim 1, wherein the predetermined thickness of the low durometer elastomer is of a non-uniform profile around the core.

25. The process of claim 1, wherein the mold member includes a plurality of mold components moving in series to allow curing of the parts in a continuous fashion.

26. The process of claim 1, further comprising the step of:
transporting the core and low durometer elastomer thereon on a conveyor during curing of the low durometer elastomer.

27. The process of claim 1, wherein the core is made of injection molded plastic.

28. The process of claim 1, wherein the core is made of metal.

29. The process of claim 1, further comprising the step of:
injection molding the core in-line prior to the low durometer elastomer.

30. The process of claim 1, wherein the core is of sufficient length to make multiple parts when cut post molding.

31. A process for making a soft touch outer surface for an object, comprising the steps of:
providing a core to receive a soft touch outer surface thereon;
providing a mold member having a mold cavity;
placing the core inside the mold cavity;
injecting a low density foamed plastic, having a specific gravity between 0.1 and 0.7, into the mold cavity to surround the core in 360 degrees with a predetermined thickness;
demolding the core with low density foamed plastic thereon having an outer surface; and
covering the outer surface of the low density foamed plastic with a finish layer.

32. The process of claim 31, wherein the finish layer is paint.

33. The process of claim 32, wherein the paint is elastomeric.

34. The process of claim 32, where the paint is an elastomeric polyurethane.

35. The process of claim 32, further comprising the step of:
spraying paint onto the outer surface of the low density foamed plastic.

36. The process of claim 35, further comprising the step of:
rotating the core 360 degrees during the step of spraying paint onto the outer surface of the low density foamed plastic.

37. The process of claim 31, further comprising the step of:
covering paint on the outer surface of the low density foamed plastic by dipping.

38. The process of claim 31, wherein the finish layer is fabric.

39. The process of claim 38, wherein the fabric is tubular in configuration.

40. The process of claim 38, wherein the fabric is made of a material selected from the group consisting of braided, circular knit and heat shrinkable.

41. The process of claim 31, wherein the finish layer is film.

42. The process of claim 41, wherein the film is made of a material selected from the group consisting of: polyurethane, EVA, polyethylene, polyester, nylon and polypropylene.

43. The process of claim 31, wherein the core is rigid.

44. The process of claim 31, wherein the core is semi-rigid.

45. The process of claim 31, wherein the low density foamed plastic is made of a material selected from the group consisting of: polyurethane, polyethylene and EVA.

46. The process of claim 31, wherein the core is a writing instrument.

47. The process of claim 31, wherein the core is handle of a razor.

48. The process of claim 31, wherein the core is an eyeglass frame.

49. The process of claim 31, wherein the core is a beverage container.

50. The process of claim 31, wherein the low density foamed plastic has a cure time of greater than 1 minute.

51. The process of claim 31, wherein the low density foamed plastic has a cure time of greater than 3 minutes.

52. The process of claim 31, wherein the mold member is made of plastic.

53. The process of claim 31, further comprising the step of:
covering the mold member with a non-transferring release agent prior to injecting the low density foamed plastic into the mold cavity.

54. The process in of claim 53, wherein the release agent is cross-linked.

55. The process of claim 31, wherein the predetermined thickness of the low density foamed plastic is of a non-uniform profile around the core.

56. The process of claim 31, wherein the mold member includes a plurality of mold components moving in series to allow curing of the parts in a continuous fashion.

57. The process of claim 31, further comprising the step of:
transporting the core and low density foamed plastic thereon on a conveyor during curing of the low density foamed plastic.

58. The process of claim 31, wherein the core is made of injection molded plastic.

59. The process of claim 31, wherein the core is made of metal.

60. The process of claim 31, further comprising the step of:
injection molding the core in-line prior to the low density foamed plastic.

61. The process of claim 31, wherein the core is of sufficient length to make multiple parts when cut post molding.
